(19) United States
(12) Patent Application Publication
(10) Pub. No.: US 2012/0095855 A1
(43) Pub. Date: Apr. 19, 2012

(54) Systems and methods for buyer-initiated mobile payments without sensitive information exchange between buyer and seller

(76) Inventor: Jacob Matthew Sterling, Creve Coeur, MO (US)

(21) Appl. No.: 13/295,197

(22) Filed: Nov. 14, 2011

Related U.S. Application Data
(60) Provisional application No. 61/427,623, filed on Dec. 28, 2010.

(51) Int. Cl. G06Q 30/06

(52) U.S. Cl. 705/16; 705/26.41

(57) ABSTRACT

Systems and methods for effecting mobile purchases and removing the necessity of financial and personal information exchange directly between buyers and sellers, where the buyer uses a personal mobile device to effect payment. Instead of using sensitive and/or easily compromised data to perform a transaction, the seller posts the purchase amount to a proxy system for recognition and claiming by the buyer. The buyer claims the purchase by selecting it via a mobile device. The seller receives a confirmation of purchase from the proxy system without direct interaction with the buyer's mobile device or personal information. The seller's point of sale no longer acts as a point of acceptance and thus no longer requires sensitive information exchange directly with the buyer.

This application claims the benefit of U.S. Provisional Application No. 61/427,623, filed Dec. 28, 2010.

### BACKGROUND OF THE INVENTION

Historically, payment for goods or services has been always initiated by the buyer: upon selection of the goods or services for purchase, the seller quoted a price and the buyer presented cash, cashlike instruments or barter for the goods or services. The option to purchase and the behavior of presenting the form of payment rested entirely with the buyer. This is a perfectly logical and ergonomically sound scenario: the buyer controlled and managed the payment while the seller controlled and managed the items of value in exchange.

The advent of electronic forms of payment has created a distinction between the method of payment (for example, a credit or debit card or the “payment instrument”) and the means of utilizing that payment (the “acceptance instrument.”) To effect payment, the seller's point of acceptance must directly interact with the method of payment, for example by swiping a credit card at the point of sale or scanning a check to generate an image. The information is then used by the seller to authorize the transaction on the buyer's behalf. In effect, the seller appropriates and controls the buyer's data. There is no recourse to this model because the buyer cannot present transactions to the payment network directly; only the seller is authorized to present transactions. Therefore, the original and natural payment paradigm of buyer-initiated purchasing has been supplanted with seller-initiated purchasing as a consequence of electronification.

This electronic payment paradigm prevents effective buyer management of payment and other sensitive data, because the buyer is forced to relinquish this data to the seller's control in order for the payments network to function. Moreover, since the acceptance instrument is a single point of focus (some would say failure) in electronic payments, the payment process itself can only be as ergonomic and customer-friendly as the capabilities of the acceptance instrument itself. Presented against the backdrop of historical payment, electronification of payment has therefore created two unnecessary and undesirable byproducts: first, the introduction of and dependency on the acceptance instrument and the corresponding bottleneck on innovation it represents; second, the unfortunate requirement of sensitive data exchange between buyer and seller and the corresponding risks of proliferation of that data.

There is currently a significant amount of innovation in the arena of mobile payments. In its broadest definition, “mobile payments” tends to refer to the replacement of the buyer's payment instrument—historically a plastic card, paper check or physical cash—with a handheld mobile device such as a mobile phone, personal digital assistant or tablet computer. Other treatments of “mobile payments” involve the replacement of the seller's payment acceptance device—historically a point of sale terminal—with another handheld mobile device. However, current treatments of “mobile payments” tend to perpetuate the existing distinction between the payment instrument and the acceptance instrument. For example, using near field communications (NFC) to enable a buyer to “bump” his mobile phone against a NFC reader, whether in a physical point of sale or a second mobile phone, is nothing more than a new technology treatment of the same distinction between the payment and acceptance instruments.

### DESCRIPTION OF THE INVENTION

The invention is designed to use a combination of existing and new technologies, and a new business method overlaid on top of those technologies, to effect a true buyer-initiated and buyer-controlled payment paradigm. The new paradigm can exist on top of virtually any existing payment network, but change the interaction at the moment of purchase so that the buyer uses his mobile device to control the purchase without requiring any direct exchange of data with the seller or the seller's point of sale. In effect, the buyer's mobile device becomes both the payment instrument and the acceptance instrument simultaneously.

The invention contemplates the use of three primary elements to facilitate secure buyer-initiated transactions from a mobile device:
(a) The customer or buyer's mobile device itself (the “Buyer Device”), which may take the form of a mobile/cellular phone, a tablet or portable computer, personal digital assistant, or other device, the critical criterion being that it is designed to support data as well as voice communications. Typically data communications will be performed over market-standard physical and logical transport protocols, such as Wi-Fi or Bluetooth, with higher level protocols such as IP and SSL supported upon the core transport protocol. For the sake of clarity, in some embodiments the Buyer Device may encompass the entire physical device itself, while in other embodiments the Buyer Device may be a portion of a physical device or a software application, library or subroutine resident on a physical device.
(b) The retailer or seller's point of sale system (the “Seller Device”), which will generally take the form of a standalone tabletop point of sale unit, an integrated software application residing on a standard PC, or PC-like computer platform built expressly for the purpose of supporting retail sales (such as a computer-based grocery store checkout system.) In some embodiments, the point of sale system could also take the form of a mobile device as in 7(a) above, with the sole distinction being that it represents the retailer/seller as opposed to the customer/buyer. Typically, point of sale systems support multiple communications methods, including common standards such as IP over wired or wireless networks; furthermore, some systems either directly support personal-area network protocols like Bluetooth or are linked to in-store networks that do. For the sake of clarity, in some embodiments the Seller Device may encompass the entire physical device itself, while in other embodiments the Seller Device may be a portion of a physical device or a software application, library or subroutine resident on a physical device.
(c) A payment proxy system (the “Proxy”), which may take the form of a computer software application combined with hardware and communications capabilities allowing it to be accessed by both the Buyer Device and the Seller Device. In one embodiment of the invention, the Proxy is a distributed software application with logic residing both on dedicated computer equipment as well as the Buyer Device. In another embodiment, the Proxy resides solely on dedicated computer equipment accessible to the Buyer Device and Seller Device via standard network and telecommunication protocols, either on the retailer premises or in the geographic vicinity. In another embodiment, the Proxy resides in a separate geographic area or may be virtualized across multiple computer devices or locations via “cloud” computing and similar technologies, whether or not a portion of the Proxy exists on the Buyer Device. In another embodiment, multiple Proxies are utilized, where one or more interact with a population of Buyer Devices and one or more interact with a population of Seller Devices. In another embodiment, a Proxy may be associated with a fixed population of Seller Devices, for example in a single retail location or collection of retail locations (such as a shopping mall.) In still another embodiment, a Proxy may be associated with a specific area or checkout lane of a retail establishment, with a single Seller Device in that area.
(d) Depending on the embodiment of the invention, any or all the elements described above may take physical or virtual form. In some embodiments, each element may reside within the framework of a larger system or device. For example, a Buyer Device may take the form of a downloadable software application for a mass-marketed mobile phone, a Seller Device may take the form of software code running on a physical point-of-sale system, and a Proxy may take the form of software code running on mass-produced computer hardware. This example is of course illustrative and not intended to proscribe the range of potential embodiments of each element described herein.

The elements described in 7 interact in a prescribed fashion to obviate the need for direct data exchange between the Buyer Device and Seller Device, while guaranteeing buyer control over the purchase and seller receipt of funds.

A primary aspect of the invention is that the Buyer Device and Seller Device only interact with the Proxy, irrespective of the form the Proxy may take, whether as described in 7(c) or in an embodiment or form not specifically claimed herein. If elements of the Proxy reside on the Buyer Device, those elements are only resident on the Buyer Device to the extent they interact directly with the Buyer and are used to facilitate communication between the Buyer Device and the Proxy alone.

In some embodiments, the Seller Device in 7(b), or the equipment in which the Seller Device resides, will clearly be used for purposes outside the scope of the invention and not claimed herein. These purposes include the common and routine actions involved with preparing a purchase for payment, such as scanning product bar codes, calculating sales tax, applying discounts and so on. The Seller Device may also be equipped to accept forms and methods of payment outside the scope of the invention, such as cash, checks, payment cards, whether physically presented at the point of sale for direct data access (for example, by swiping a magnetic stripe or reading an onboard chip) or mobile devices equipped with a payment wallet, if the payment feature is actuated by direct interaction with the Seller Device (for example, by waving a phone with NFC capability near a proximity reader.)

The Buyer Device, Seller Device and Proxy interact according to the following process phases.

To establish the ability for the Buyer Device and Seller Device to conduct transactions, both devices identify and associate themselves to the Proxy (or Proxies, if multiple are used) in advance of any transaction taking place. This identification is referred to in the invention as the Discovery Phase and is represented in FIG. 1. The invention does not expect the discovery of both devices to be simultaneous. Indeed, the invention assumes the discovery of each device takes place at substantially different periods in time. In some embodiments, either or both the Buyer and Seller Device may only progress through the Discovery Phase at the moment the transaction must take place.

Also implicit in the Discovery Phase is the implication that a device may cease to be associated with a Proxy for various reasons. In one embodiment, a Buyer or Seller Device may cease to be associated for technological reasons, such as distance from the Proxy, a period of inactivity, physical equipment failure, and so on. In another embodiment, a device may cease to be associated for business reasons, such as transaction control, suspicion of fraud, suspension of transaction privileges, and so on. In some embodiments, a device may be restricted to only one Proxy association at a time, while in other embodiments, a device may have multiple simultaneous Proxy associates, which may operate in a peer-to-peer or primary/backup relationship, as circumstances require.

In one embodiment of the Discovery Phase, the population of Seller Devices may be fixed while the population of Buyer Devices may be fluid. This is particularly true where a Proxy is associated with a locally controlled population of Seller Devices; the Seller Devices are identified far in advance of any Buyer Device interacting with the Proxy. An example of this embodiment is a case where the Proxy is associated with a single retail establishment. The Seller Devices within the establishment may have static relationships with the Proxy and do not need to be discovered beyond their initial activation.

In another embodiment of the Discovery Phase, the population of Buyer Devices may be fixed while the population of Seller Devices may be fluid. This is particularly true where a Proxy is deliberately associated with a specific Buyer Device, which is identified far in advance of any Seller Devices interacting with the Proxy. An example of this embodiment is a case where the Proxy is associated with the receiving department of a retail establishment. As suppliers arrive at the receiving department and unload their wares, each supplier carries a Seller Device to be discovered by the Proxy associated with the Buyer Devices.

In another embodiment of the Discovery Phase, both the Buyer and Seller Device populations may be fluid. This is particularly true where a Proxy is associated with a certain geographic area of control, but the buyers and sellers within that area change over time. An example of this embodiment is an open-air market or garage/rummage sale where the traditional buyer-seller relationship is characterized more as a “person-to-person” interaction than as a “customer-to-retailer” interaction. Neither the Buyer nor the Seller Device may have a pre-established association with a specific Proxy, and therefore both devices must be discovered by the Proxy facilitating transactions for that local area before the transaction may proceed.

When the seller has tabulated the value of the purchase and is ready for the purchase to occur, he or she informs the Proxy facilitating the transaction that the purchase is ready to be made. This is performed via the Checkout and Posting Phase, as represented in FIG. 2. Implicit within this phase is the requirement that the Seller Device has already passed through the Discovery Phase as discussed in 12 through 16 above.

The Seller Device transmits certain data elements of the purchase to the Proxy, such as the transaction amount, transaction currency, datestamp/timestamp, and other data that will identify the purchase as coming from a specific Seller Device. In an embodiment, the Seller Device transmits only the minimum data required to facilitate the transaction processing. In another embodiment, the Seller Device may also transmit additional information used to identify the location of a transaction to aid in associating it with a buyer—for example, device or location data. In still other embodiments, the Seller Device transmits a richer set of data to facilitate marketing opportunities associated with the purchase, for example item information, special offers and so on; product warranty information; purchase terms and conditions; preferred payment methods; and other information pertaining to the purchase.

The Proxy acknowledges receipt of the data elements from the Seller Device and updates the status associated with that device to reflect that it has posted a transaction that is as yet incomplete. The Seller Device moves to a status of waiting for the transaction to complete. In an embodiment, the Seller Device will perform no other action until the transaction either completes or is rejected for various reasons (e.g. buyer declined to purchase, timeout, etc.) In another embodiment, the Seller Device will proceed to the next transaction and rely on the Proxy to indicate when the first is complete. This embodiment may be especially useful for environments where a single Seller Device is designed to interact with multiple Buyer Devices simultaneously.

When the Proxy has received the transaction posted by the Seller Device as outlined in 19 above, the Buyer Device or Devices discovered by that Proxy are able to view the transaction as posted. The Buyer Device associated with the buyer then claims the transaction as its own via the Claiming Phase, as represented in FIG. 3. The act of claiming is a buyer-initiated event that enforces ultimate purchase control with the buyer, according to the core intentions of the invention. By claiming a transaction, the Buyer Device informs the Proxy that it is the device that “owns” the transaction and will be responsible for its completion.

The manner in which the Buyer Device recognizes a transaction is available for claiming will vary by embodiment. In some embodiments, the Proxy may broadcast or the status of available transactions to a population of associated Buyer Devices (a “push” method.) In other embodiments, the Buyer Devices may routinely poll the Proxy to determine whether any available transactions exist (a “pull” method.)

The “push” and “pull” methods described in 21 may be further refined by the use of data and technologies to restrict the visibility of the transaction to only those Buyer Devices most closely associated with the Seller Device that posted the transaction in the Checkout and Posting Phase. For example, a Proxy and Buyer Device may exchange location information that will be compared to location information transmitted by the Seller Device during transaction posting to present only that transaction for claiming. This example is for illustrative purposes only; the invention is not intended to be concerned with the specific methods or technologies used to facilitate filtering of available transactions, as numerous methods and technologies already exist in the public domain and are likely to be created in the future.

Regardless of the method used by the Buyer Device to recognize the transaction, the buyer uses the Buyer Device to claim a transaction for purchase. The Buyer Device then notifies the Proxy of the claim event and in some embodiments the Proxy subsequently notifies the Seller Device the transaction has been claimed. In other embodiments, the Proxy may not notify the Seller Device until the transaction has actually been confirmed and paid in a later phase. In still other embodiments (for example, in cases where buyer anonymity is not desirable or necessary), the Proxy may include certain buyer identification data along with the claim notification provided to the Seller Device.

At this point in the process, the transaction has been generated by the Seller Device and successfully claimed by a Buyer Device. However, claiming does not generally constitute buyer acceptance of the purchase or actual payment. The Buyer Device now presents the buyer with the opportunity to review the transaction and accept or reject it before payment. This is the Confirmation Phase as illustrated in FIG. 4. Again, confirmation is a buyer-initiated event that remains within the buyer's complete control.

If a transaction is confirmed (accepted,) the process will continue per 26 and following. If, however, a transaction is rejected, the Buyer Device will inform the Proxy the transaction has been rejected. From this point, the process may vary. In an embodiment, the Buyer Device also supplies rejection reason data to the Proxy, which may be returned to the Seller Device either for informational purposes or to provide the seller a chance to remedy the problem with the transaction. In another embodiment, the Buyer Device may automatically reject a transaction for various reasons; for example, the purchase amount is too high, a daily purchase limit may have been reached, the seller is unrecognized or untrusted, the items purchased are not appropriate for the buyer (i.e. age-restricted items such as liquor), and so on. In another embodiment, the Buyer Device may reject a transaction because it is intended to be claimed by a separate Buyer Device; for example, a friend wishes to make the purchase as a gift to the original buyer. In another embodiment, the Buyer Device may temporarily reject a transaction in favor of completing it at a later time.

The Buyer Device informs the Proxy the transaction has been confirmed. The Proxy may in turn notify the Seller Device the transaction has been confirmed, but in some embodiments this notification may be absent or combined with the claim notification to the Seller Device as discussed in 23.

In an embodiment, the Seller Device and Buyer Device use the notifications generated by the Proxy to create a physical or virtual receipt or invoice for the transaction reflecting that it was claimed and confirmed (and potentially adjusted, if any adjustments were made as a result of rejection and remediation as discussed in 25.) In another embodiment, the receipt or invoice are not created until a later phase.

In an embodiment, the Confirmation Phase includes the selection of the payment method to be used to make payment for the purchase. In another embodiment, the payment method may be selected through a separate process outside the scope of this invention (for example, by the invention interacting with a mobile wallet application that is used to consummate the purchase.) In another embodiment, the Buyer Device may be configured to perform certain payments automatically according to established rules. Examples include, but are not limited to, routing all payments to the mobile phone service carrier for billing on the monthly statement, choosing a debit payment instrument for transactions smaller than a threshold value and a credit instrument for transactions above that value, automatically invoking a particular payment method based on the preferences declared by the Seller Device as discussed in 18, and so on.

When the transaction has been confirmed, the Buyer Device is then used to facilitate actual payment for the purchase. This occurs during the Financial Phase as illustrated in FIG. 5. The particulars of payment will be unique to the particular financial network or authority with whom the buyer interacts. The invention is not concerned with these particulars, rather the access to and invocation of them, and the use of any of their artifacts or byproducts to facilitate the phases of the invention method (for example, the use of a digitized signature by the buyer as part of the Financial Phase may also be used by the Proxy to enrich the receipt on both the Buyer and Seller Device to include a digital representation of the buyer's signature.)

In some embodiments, the method of payment will not be known or announced to either the Proxy or Seller Device. In these embodiments the buyer and his or her choice of payment method may be effectively anonymous. In other embodiments, the Buyer Device will notify the Proxy of his or her choice, but the Proxy may not notify the Seller Device. In still other embodiments, the Proxy will notify the Seller Device of the choice of payment.

In some embodiments, the buyer's choice of payment may change the purchase amount or terms associated with the purchase. This is effected by linking the Financial Phase to the Confirmation Phase, so that a buyer may re-confirm the purchase if the transaction criteria change as a result of payment method selection. For example, a buyer using a method of payment that incurs a larger cost of acceptance to a seller may be returned to the Confirmation Phase to confirm that a surcharge to recover the cost of the payment method is acceptable. In another embodiment, a buyer may select a method of payment that affords the option automatically to receive rebates, discount coupons, or other incentives that offset the purchase amount. In such cases, the buyer may be returned to the Confirmation Phase to confirm the use of any incentives to offset the purchase amount before returning to the Financial Phase.

The buyer then might exit the scope of the invention to perform the actual financial element of the purchase; for example, the Buyer Device may invoke a mobile wallet and wait in a suspended state until notification from the wallet is received that the purchase amount has been authorized and approved. In other embodiments, the Proxy may act as the agent for the financial network and inform the Buyer Device when purchase authorization approval has taken place.

Actual funds transfer from buyer to seller may occur in real time during the Financial Phase, or at a later time using established funds transfer methods such as electronic funds transfer (EFT) or Automated Clearing House (ACH.) The act of funds transfer is generally governed by existing processes in the public domain and/or through proprietary methods, and is not contemplated within the scope of the invention.

In some embodiments, the buyer may be offered the option to select a different method of payment if the financial element of the transaction fails to process with the originally selected method. This selection of a secondary or backup method of payment may in turn necessitate a re-confirmation of the purchase and a subsequent financial process as discussed in 24 to 33 preceding.

When the Financial Phase is complete, the purchase has been consummated by the buyer and the Buyer Device informs the Proxy that the financial element of the transaction has been completed successfully. This event triggers final completion of the transaction during the Closing Phase as illustrated in FIG. 6.

During the Closing Phase, the Proxy updates the status of the transaction to complete and closed, and notifies either or both the Buyer and Seller Devices that the transaction is closed. In some embodiments, the devices will not allow further transactions until the Proxy informs them of the closed status of the current transaction.

In other embodiments, either device may already have proceeded on to the next transaction, or instead have moved to a state of readiness for a subsequent transaction.

In an embodiment, the Proxy may supply additional information along with the closure notification discussed in 36 to support continued buyer and seller interaction, for example final information to be delivered to a physical or virtual receipt, marketing engagements, offers applicable to future transactions, and so on.

The Buyer Device and Seller Device also may use the closure notification discussed in 36 to disassociate themselves from the Proxy (depending on the relationship with each device and the Proxy as defined in the embodiments discussed in 12 through 16). In some embodiments, this dissociation may be initiated by the Buyer or Seller Device and received by the Proxy. In other embodiments, dissociation may automatically occur at the Proxy as a consequence of entering the Closing Phase. In still other embodiments, the Buyer and/or Seller Device may retain their association with a given Proxy, but simply be registered in a status of no transaction pending.

Upon entering the Closing Phase, the seller provides the goods and services purchased to the buyer, concluding the physical dimension of the transaction. In some embodiments, the Closing Phase will not be allowed to conclude without some type of recognition from the buyer that the goods and services were received. This recognition may take the form of a final confirmation upon the Buyer Device. In other embodiments, this recognition will be conducted within the Confirmation Phase as a natural outcome of transaction confirmation.

Upon conclusion of the Closing Phase, the purchase has been completed, the buyer has controlled his or her payment information and sensitive data throughout the process, and the seller has received adequate confirmation and/or guarantee of payment. The Buyer Device and Seller Device conclude their interaction with the Proxy for the purpose of the transaction. In some embodiments, the Proxy may write a record of the transaction to some type of storage media; in other embodiments, the Proxy may erase all record of the transaction in environments where it is neither desirable or necessary to maintain such records (for example, if the financial network accessed during the Financial Phase keeps adequate record of the transaction.)

### BRIEF DESCRIPTION OF DRAWINGS

FIG. 1: Discovery Phase

In the Discovery Phase, both the point of sale (representing the retailer) and the mobile device (representing the customer) identify themselves to the Payment Proxy for the purpose of conducting a transaction.

FIG. 2: Checkout and Posting Phase

In the Checkout and Posting Phase, the buyer and seller interact as normal for the purposes of presenting the goods for purchase (for example, the buyer removes them from a shopping basket) and tabulating the cost of the purchase (for example, by scanning the goods across a bar code reader.) When the purchase price has been tabulated, the seller uses the Seller Device to post the transaction to the Proxy as ready to be purchased.

FIG. 3: Claiming Phase

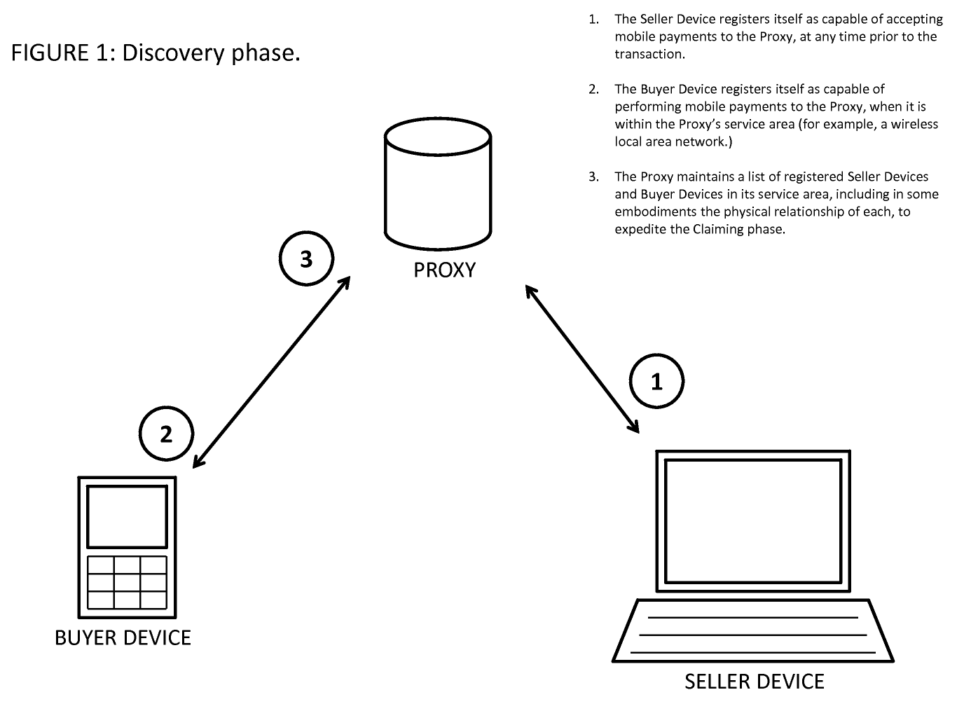

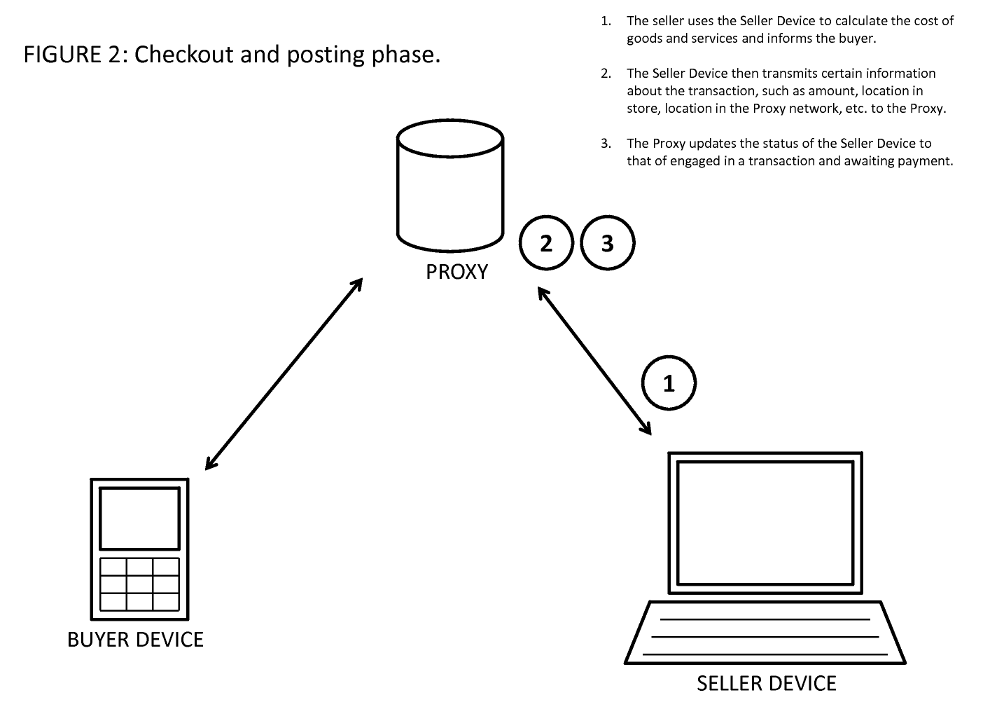

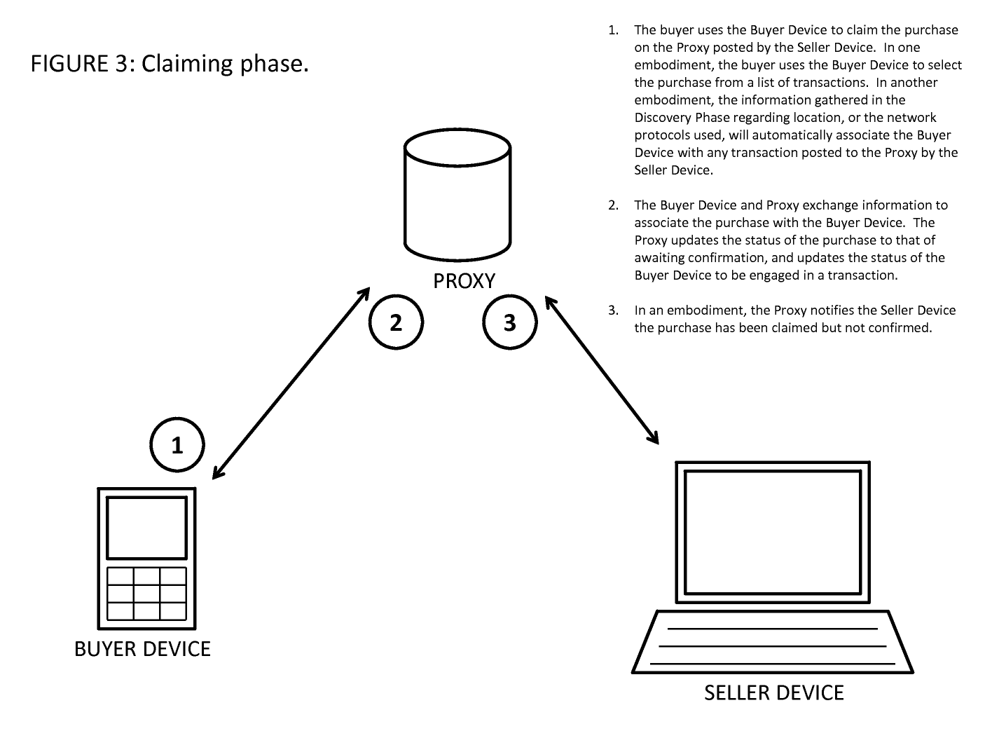

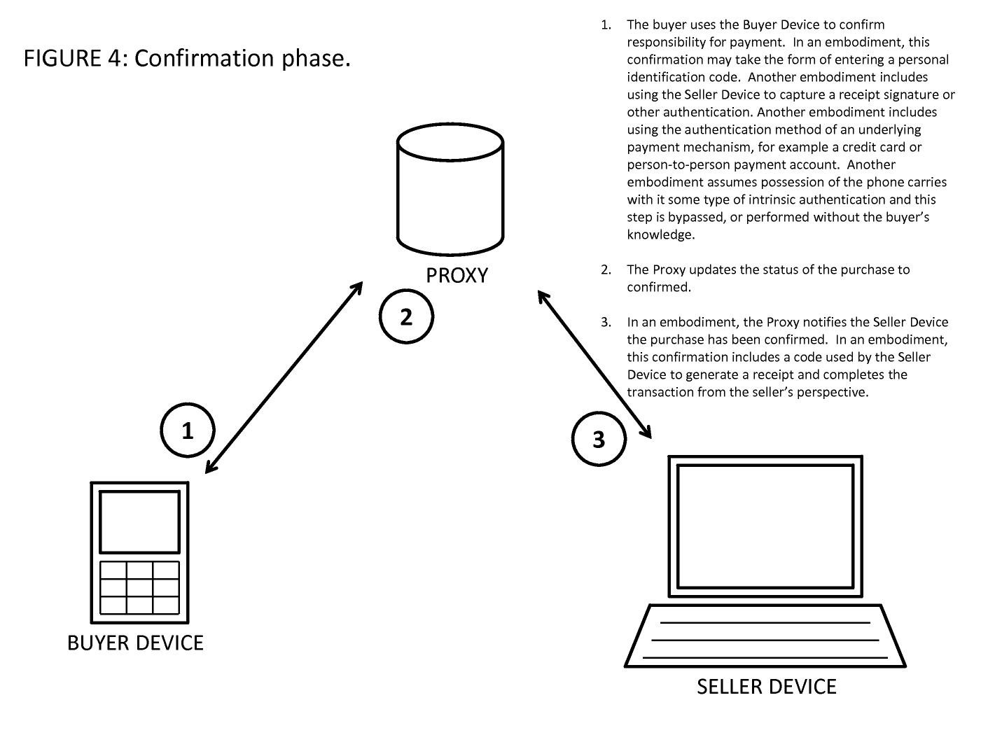

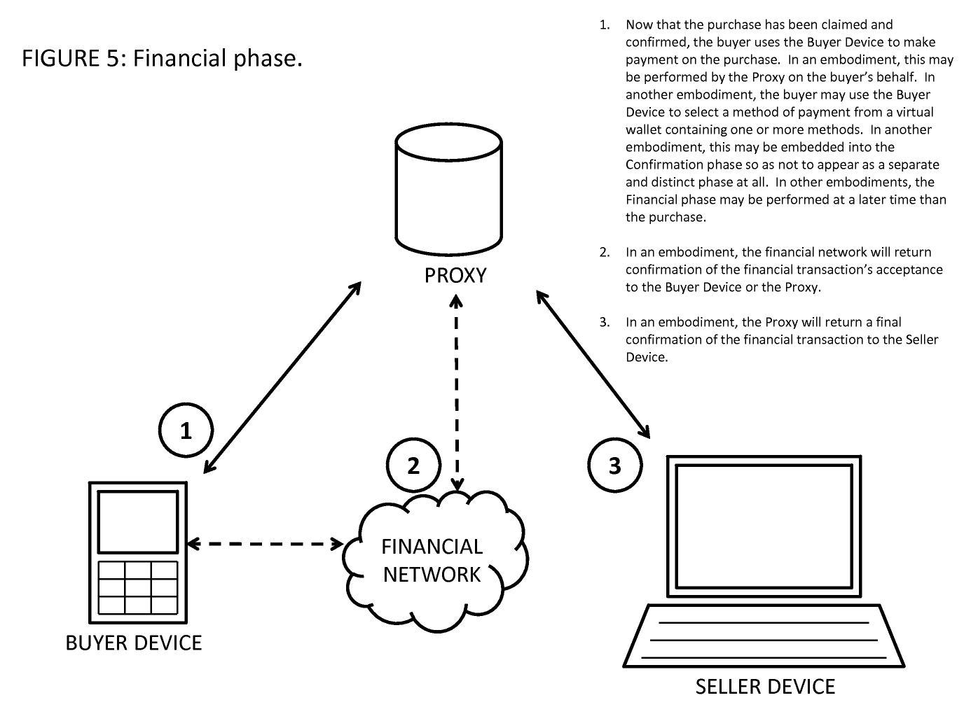

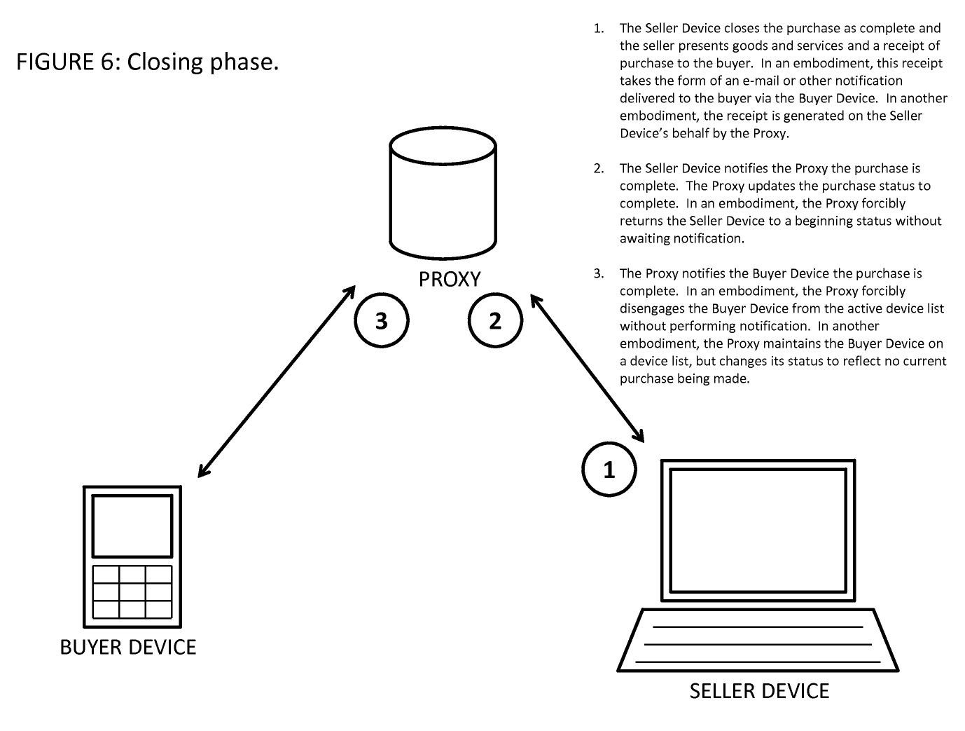

In the Claiming Phase, the buyer uses the Buyer Device to examine the Proxy for available transactions posted by the Seller Device representing the seller involved in the transaction. Depending on the relationship between the Proxy and each device, the Buyer Device may be presented with a single transaction or a list of transactions. In any case, the buyer uses the Buyer Device to select and “claim” the transaction. The Proxy then associates the transaction with that particular Buyer Device and in some embodiments informs the Seller Device the purchase has been claimed but not yet confirmed or paid.

FIG. 4: Confirmation Phase

In the Confirmation Phase, the buyer uses the Buyer Device to approve payment for the purchase claimed by the buyer in the preceding phase. The Proxy notifies the Seller Device that the purchase has been confirmed. In some embodiments, the Financial Phase will occur before the Proxy makes any notification to the Seller Device. In other embodiments, the Financial Phase will occur after the Confirmation Phase. In other embodiments, the Confirmation and Financial Phases are simultaneous. In any case, the Seller Device uses the notification of confirmation from the Proxy to finalize the purchase receipt or invoice (for devices capable of producing such receipt or invoice.) In an embodiment, the Proxy also provides a confirmation code to both devices for future transaction tracking.

FIG. 5: Financial Phase

In the Financial Phase, the actual payment approved by the buyer in the Confirmation Phase takes place. In some embodiments, the Financial Phase takes place before or simultaneous to the Confirmation Phase. In other embodiments, a financial authority may guarantee payment to the seller before the buyer actually performs payment. In any case, the Financial Phase effects the transfer of funds from the buyer or buyer's representative and initiates the transfer of funds to the seller or the seller's representative. In an embodiment, the Proxy provides a confirmation code to both devices for future transaction tracking. In another embodiment, the Seller Device uses confirmation data received in the Confirmation and Financial Phases to provide an enriched purchase receipt or invoice to assist the buyer in transaction reconciliation.

FIG. 6: Closing Phase

In the Closing Phase, both the Buyer and Seller Device cease interacting with the Proxy for the now-complete transaction (although other interactions with the Proxy may continue.) The Proxy may provide receipt or confirmation information back to the Buyer or Seller Device in lieu of a paper receipt or invoice. In any case, the Proxy updates the status of both devices to reflect the transaction is complete.

What is claimed is:

1. A system for facilitating purchases between buyers and sellers, using any common form of electronic payment, without the need to exchange financial data of any kind directly between the buyer and the seller at the moment of purchase, said method comprising: a consumer-facing computer application resident on or available to a buyer's mobile device, which allows the buyer to identify his or her ability to pay, claim and confirm purchases from the seller; a computer application resident on or available to a seller's payment acceptance device, which allows the seller to register his or her ability to accept payment, post available transactions and receive confirmation of buyer actions; a computer application segregated from direct buyer or seller intervention, accessible to the applications representing the buyer and seller, which manages a real-time registry of buyers, sellers, outstanding and claimed transactions, includes the capability to interact with established payment systems and technologies to effect final funds transfer, and is specifically designed to prevent financial data from transferring directly between buyers and sellers; and the specific methods of buyer and seller registration, identification, purchase posting, claiming and confirmation as set forth below.

2. The method of claim 1, where the application associated with the buyer resides on the buyer's mobile device in whole or in part.

3. The method of claim 1, where the application associated with the buyer resides separately from the buyer's mobile device, and is accessed via public or private networks, regardless of the physical form or communications protocol used in those networks. To be clear, the form and protocols are not to be considered part of this method or of the claim, and indeed the invention contemplates interaction with industry standard network implementations.

4. The method of claim 1, where the application associated with the buyer is activated by direct manual intervention, such as the buyer interacting with his or her device to invoke the application or service.

5. The method of claim 1, where the application associated with the buyer is activated by means of a secondary triggering device, such as a RFID readable sticker affixed on or near the seller's payment acceptance device.

6. The method of claim 1, where the application associated with the buyer is continuously operating and routinely evaluates its ability to connect with the application managing the real-time registry of buyers and sellers.

7. The method of claim 1, where the application associated with the seller resides in whole or in part on a traditional point-of-sale platform, such as a credit card terminal or electronic cash register.

8. The method of claim 1, where the application associated with the seller resides in whole or in part on a mobile device used by the seller to consummate a payment transaction with the buyer.

9. The method of claim 1, where the application associated with the seller is activated by means of a secondary triggering device, such as a RFID readable sticker affixed on or near the buyer or seller's devices.

10. The method of claim 1, where the buyer and seller are in separate physical locations and only interact by means of a remote shopping experience (such as an internet web site.)

11. The method of claim 1, where the individual performing the shopping and the individual making the purchase are separate and distinct (such as a parent buying school supplies for a child.)

12. A method for processing buyer-initiated purchase transactions using the systems as set forth in claim 1, comprising the steps of:
(a) discovery and/or registration of available buyers and sellers;
(b) recognition of pending purchases from sellers;
(c) claiming pending purchases by buyers/associating pending purchases to buyers;
(d) confirming buyer purchase decisions to both buyers and sellers;
(e) reconciling purchases for the purpose of transaction completion, receipt generation, funds transfer and tracing.

13. The method of claim 12, where a single computer system manages all the steps as set forth in the claim.

14. The method of claim 12, where multiple computer systems in a networked architecture manage the steps set forth in the claim, with the responsibility for management of each individual step distributed to the system best equipped to manage it.

15. The method of claim 12, where the system(s) responsible for discovery and/or registration of buyers and sellers is/are dedicated to a single seller's establishment (such as a single retail store) or residence.

16. The method of claim 12, where the system(s) responsible for discovery and/or registration is/are implemented to manage multiple sellers in a fixed or variable geography (such as a shopping mall or flea market.)

17. The method of claim 12, where the system(s) responsible for the entire method is/are implemented to manage the transfer or handoff of a buyer and/or seller from one system to another while preserving the state of the current transaction, to facilitate transactions between entities traveling between two areas in a geographic coverage paradigm (such as a buyer traveling on a train or airplane making an onboard purchase.)
